(19) United States
(12) Patent Application Publication
(10) Pub. No.: US 2018/0126338 A1
(43) Pub. Date: May 10, 2018

(54) NEW POLYMER COMPOSITIONS

(71) Applicant: BASF SE, Ludwigshafen (DE)

(72) Inventors: Martin WEBER, Maikammer (DE); Berend ELING, Lemfoerde (DE); Martin HEIJNEN, Landsberg am Lech (DE); Oliver GRONWALD, Heusenstamm (DE); Hartwig VOSS, Frankenthal (DE); Jacek MALISZ, Limburgerhof (DE); Davis Yohanes ARIFIN, Singapore (SG)

(73) Assignee: BASF SE, Ludwigshafen (DE)

(21) Appl. No.: 15/574,511

(22) PCT Filed: May 19, 2016
(86) PCT No.: PCT/EP2016/061213

§ 371 Date: Nov. 16, 2017

(30) Foreign Application Priority Data
May 19, 2015 (EP) 15168057.6

(51) Int. Cl. B01D 71/54; B01D 71/68; B01D 71/70; B01D 71/80; B01D 67/00; B01D 69/02; B01D 69/14; C08G 18/76; C08G 18/63; C08G 18/48; C08G 18/40; C08J 5/18; C08L 75/08

(52) U.S. Cl. CPC B01D 71/54; C08J 2375/08; B01D 71/70; B01D 71/80; B01D 67/0079; B01D 69/02; B01D 69/148; C08G 18/7671; C08G 18/632; C08G 18/4879; C08G 18/4072; C08J 5/18; C08L 75/08; B01D 2325/48; C08G 2340/00; B01D 71/68

(57) ABSTRACT

Polymer composition comprising a) an oligo- or polyurethane U of the formula (I) wherein k and n independently are numbers from 1 to 100, m is from the range 1-100, (X) is a block of formula (II) and (Y) is a block of the formula (III), (A) is a residue of an aliphatic or aromatic diisocyanate linker, (B) is a residue of a linear oligo- or polysiloxane containing alkanol end groups, and optionally further containing one or more aliphatic ether moieties, and (C) is an aromatic oligo- or polyarylene ether block that is at least partly etherified at its terminal positions with one alkylene glycol unit; or a mixture of such oligo- or polyurethanes; and b) one or more further organic polymers P selected from the group consisting of polyvinyl pyrrolidone, polyvinyl acetates, cellulose acetates, polyacrylonitriles, polyamides, polyolefines, polyesters, polyarylene ethers, polysulfones, polyethersulfones, polyphenylenesulfones, polycarbonates, polyether ketones, sulfonated polyether ketones, polyamide sulfones, polyvinylidene fluorides, polyvinylchlorides, polystyrenes and polytetrafluorethylenes, copolymers thereof, and mixtures thereof; preferably selected from the group consisting of polysulfones, polyphenylenes, polyethersulfones, polyvinylidene fluorides, polyamides, cellulose acetate and mixtures thereof.

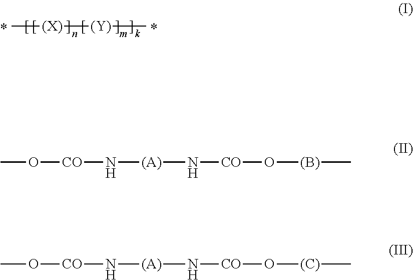

The instant invention relates to Polymer composition comprising
a) an oligo- or polyurethane of the formula I

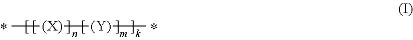

wherein k and n independently are numbers from 1 to 100,

m is from the range 1-100,

(X) is a block of formula

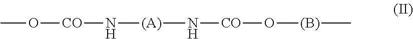

and (Y) is a block of the formula

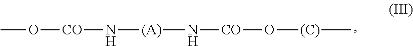

(A) is a residue of an aliphatic or aromatic diisocyanate linker,
(B) is a residue of a linear oligo- or polysiloxane containing alkanol end groups, and optionally further containing one or more aliphatic ether moieties, and
(C) is an aromatic oligo- or polyarylene ether block that is at least partly etherified at its terminal positions with one ethylene glycol unit;
   or a mixture of such oligo- or polyurethanes; and
b) one or more further organic polymers selected from the group consisting of polyvinyl pyrrolidone, polyvinyl acetates, cellulose acetates, polyacrylonitriles, polyamides, polyolefines, polyesters, polysulfones, polyethersulfones, polyphenylenesulfones, polycarbonates, polyether ketones, sulfonated polyether ketones, polyamide sulfones, polyvinylidene fluorides, polyvinylchlorides, polystyrenes and polytetrafluorethylenes, copolymers thereof, and mixtures thereof; preferably selected from the group consisting of polysulfones, polyethersulfones, polyphenylenesulfones, polyvinylidene fluorides, polyamides, cellulose acetate and mixtures thereof.

The problem of biofouling is pronounced in semipermeable membranes used for separation purposes like microfiltration, ultrafiltration or reverse osmosis. Membranes may be classified according to their pore dimension in most of the application profiles. For example, in water filtration applications ultrafiltration membranes are used for wastewater treatment retaining organic and bioorganic material. Much smaller diameters are required in desalination applications for retaining ions. In these applications, the ambient medium is an aqueous phase, where potential blockage may occur by adhesion of micro-organisms and bio-film formation. In consequence, a membrane with anti-adhesion properties is desired, which would reduce bio-film formation and thus require less cleaning cycles.

U.S. Pat. No. 5,102,547 proposes various methods for the incorporation of oligodynamic materials including silver powders and silver colloids into membranes.

U.S. Pat. No. 6,652,751 compares several bacteriostatic membranes obtained after contacting polymer solutions containing a metal salt with a coagulation bath containing a reducing agent. Membranes containing certain modified polymers have also been proposed to improve fouling resistance.

WO 09/098161 discloses certain alkoxyamine-functionalized polysulfones as additives for the purpose.

WO 07/053163 recommends incorporation of certain graft-copolymers based on a polysiloxane backbone into polymeric materials such as coatings to impart antifouling properties. Hydrophobic properties of polysiloxanes have already been exploited to impart “fouling release” properties to surfaces coated by these polymers or by certain copolymers containing polysiloxane blocks (see S. Krishnan, J. Mater. Chem. 2008, 18, 3405, and references cited therein).

WO 2011/110441 discloses Polyurethane block copolymers based on polysiloxane surfactants for membranes.

It was an objective of the present invention to provide new copolymers and polymer compositions that allow for the manufacture of membranes for water treatment that show a high permeability for water and that are less prone to fouling than membranes known in the art.

Certain block-copolymers with urethane linkage have now been found, which show especially advantageous antifouling properties, herein referred to as oligo- or polyurethanes U. Due to their good compatibility, the present block-copolymers may be fully incorporated into other matrix polymers, or rigidly anchored in these matrices and enriched at the surface. Thus, the present block-copolymers may conveniently be used as an additive imparting antimicrobial and anti bioadhesion properties to polymeric articles and their surfaces, e.g. when incorporated into a membrane, especially a membrane for water filtration purposes. The present block-copolymers contain one or more polysiloxane blocks as diol component (B), whose alkanol end groups are optionally extended by one or more ether moieties. Further conveniently contained are polyarylene ether blocks (C) that are at least partly etherified with one alkylene glycol at the terminal positions as second diol component. Linkage between the diol blocks is effected by urethane linkers (A) derived from aromatic or aliphatic diisocyanates.

In one aspect, the present invention thus pertains to oligo- and polyurethanes U comprising said components (A), (B) and (C) of the formula

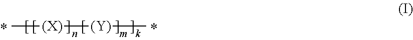

wherein k and n independently are numbers from 1 to 100,

m is from the range 1-100,

where

(X) is a block of formula

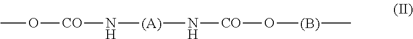

and (Y) is a block of the formula

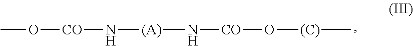

(A) is a residue of an aliphatic or aromatic diisocyanate linker,
(B) is a residue of a linear oligo- or polysiloxane containing alkanol end groups, and optionally further containing one or more aliphatic ether moieties, and
(C) is an aromatic oligo- or polyarylene ether block that is at least partly etherified at its terminal positions with one alkylene glycol unit.

The blocks (X) and (Y) in formula I may be in statistical order or, again, in blocks; the usual procedure (see present examples) yields blocks (X) and (Y) in statistical order. The moieties (A), (B) and (C) may also comprise minor amounts of tri- or polyvalent residues, e.g. by including a minor quantity of a triisocyanate and/or tetraisocyanate into the preparation of the present oligo- or polyurethane. The resulting branched species share the advantageous properties of the present linear oligo- and polyurethanes, and are included by the present invention.

Preferred oligo- and polyurethane molecules of the invention contain at least one block (X) and at least one block (Y). Preferred n and m range from 2 to 50, more preferably 2 to 20. Preferred k range from 2 to 20.

The molecular weight (Mn) of the block copolymers is preferably from the range 1500 to 100000, more preferably from the range 4000 to 25000.

Most preferred compounds show a polydispersity ranging from 1.5 to 4.0.

Preferred (A) is a divalent residue selected from C₂-C₁₂ alkylene and an aromatic/araliphatic diradical.

Preferred (A) are diradicals of commercially available diisocyanates (with the NCO groups pro forma removed) such as tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethylbiphenyl diisocyanate, 1,2-diphenylethane diisocyanate and/or phenylene diisocyanate. Preference is given to using 4,4′-MDI. Preference is also given to aliphatic diisocyanates, in particular hexamethylene diisocyanate (HDI), and particular preference is given to aromatic diisocyanates such as 2,2′-, 2,4′- and/or 4,4′-diphenylmethane diisocyanate (MDI) and mixtures of the aforementioned isomers.

Especially preferably, (A) is selected from hexamethylene (1,6-n-hexane diradical), methyl-2,4-phenylene, methyl-2,6-phenylene (diradicals of TDI), 3,3,5-trimethyl-5-methylen-3-cyclohexylen (diradical of IPDI), methylene-4,4′-diphenylen (diradical of MDI).

Preferred (B) is a divalent residue of an oligo- or polysiloxane of the formula

-[Ak-O]_{q}-Ak-Si(R₂)[O—Si(R₂)]ₚ—O—Si(R₂)-Ak-[O-Ak]_{q}′- (IV)

wherein Ak represents C₂-C₄-alkylene, R represents C₁-C₄-alkyl, and each of p, q and q′ independently is a number selected from the range 0-80. In more preferred moieties (B) of formula (IV), p ranges from 1 to 50, especially from 2 to 50.

In one embodiment, Ak represents identical alkylene units in each residue (B). In one embodiment, Ak may represent different alkylene units in the same residue (B). For example, Ak can be ethylene or propylene within the same residue (B).

Suitable polyarylene ethers (C) are known as such to those skilled in the art and can be formed from polyarylene ether blocks of the general formula (V)

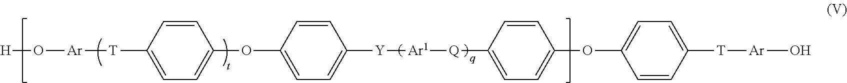

with the following definitions:

t, q: each independently 0, 1, 2 or 3,

Q, T, Y: each independently a chemical bond or group selected from —O—, —S—, —SO₂—, S═O, C═O, —N═N—, —CR^{a}R^{b}— where R^{a} and R^{b} are each independently a hydrogen atom or a C₁-C₁₂-alkyl, C₁-C₁₂-alkoxy or C₆-C₁₈-aryl group, where at least one of Q, T and Y is not —O—, and at least one of Q, T and Y is —SO₂—, and

Ar, Ar¹: each independently an arylene group having from 6 to 18 carbon atoms.

wherein the polyarylene ether blocks according to formula (V) are at least partly etherified at its terminal positions with one alkylene glycol unit. Preferred alkylene glycols are ethylene glycol, 1,2-propylen glycol, 1,3-propylene glycol and 1,4-butylene glycol. Especially preferred said alkylene glycol is ethylene glycol.

Preferably, at least 70 mol % of the terminal position of polyarylene ether blocks according to formula (V) are etherified with one alkylene glycol unit.

Thus, polyarylene ethers (C) include inter alia structural units according to formula

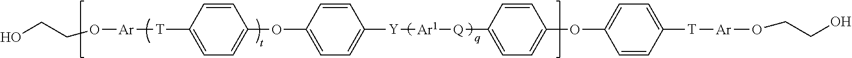

The polyarylene ethers according to formula (V) are typically prepared by polycondensation of suitable starting compounds in dipolar aprotic solvents at elevated temperature (see, for example, R. N. Johnson et al., J. Polym. Sci. A-1 5 (1967) 2375, J. E. McGrath et al., Polymer 25 (1984) 1827).

Suitable polyarylene ether blocks according to formula (V) can be provided by reacting at least one starting compound of the structure X—Ar—Y (M1) with at least one starting compound of the structure HO—Ar¹—OH (M2) in the presence of a solvent (L) and of a base (B), where
Y is a halogen atom,
X is selected from halogen atoms and OH, preferably from halogen atoms, especially F, Cl or Br, and
Ar and Ar¹ are each independently an arylene group having 6 to 18 carbon atoms.

In one embodiment, a polyarylene ether which is formed from units of the general formula V with the definitions as above is provided in the presence of a solvent (L):

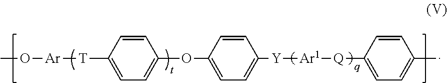

If Q, T or Y, with the abovementioned prerequisites, is a chemical bond, this is understood to mean that the group adjacent to the left and the group adjacent to the right are bonded directly to one another via a chemical bond.

Preferably, Q, T and Y in formula (V), however, are independently selected from —O— and —SO₂—, with the proviso that at least one of the group consisting of Q, T and Y is —SO₂—.

When Q, T or Y are —CR^{a}R^{b}—, R^{a} and R^{b} are each independently a hydrogen atom or a C₁-C₁₂-alkyl, C₁-C₁₂-alkoxy or C₆-C₁₈-aryl group.

Preferred C₁-C₁₂-alkyl groups comprise linear and branched, saturated alkyl groups having from 1 to 12 carbon atoms. Particularly preferred C₁-C₁₂-alkyl groups are: C₁-C₆-alkyl radicals such as methyl, ethyl, n-propyl, isopropyl, n-butyl, sec-butyl, 2- or 3-methylpentyl and longer-chain radicals such as unbranched heptyl, octyl, nonyl, decyl, undecyl, lauryl, and the singularly or multiply branched analogs thereof.

Useful alkyl radicals in the aforementioned usable C₁-C₁₂-alkoxy groups include the alkyl groups having from 1 to 12 carbon atoms defined above. Cycloalkyl radicals usable with preference comprise especially C₃-C₁₂-cycloalkyl radicals, for example cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclpentylethyl, -propyl, -butyl, -pentyl, -hexyl, cyclohexylmethyl, -dimethyl, -trimethyl.

Ar and A¹ are each independently a C₆-C₁₈-arylene group. Proceeding from the starting materials described below, Ar is preferably derived from an electron-rich aromatic substance which is preferably selected from the group consisting of hydroquinone, resorcinol, dihydroxynaphthalene, especially 2,7-dihydroxynaphthalene, and 4,4′-bisphenol. A¹ is preferably an unsubstituted C₆- or C₁₂-arylene group.

Useful C₆-C₁₈-arylene groups Ar and A¹ are especially phenylene groups, such as 1,2-, 1,3- and 1,4-phenylene, naphthylene groups, for example 1,6-, 1,7-, 2,6- and 2,7-naphthylene, and the arylene groups derived from anthracene, phenanthrene and naphthacene.

Preferably, Ar and A¹ in the preferred embodiments of the formula (V) are each independently selected from the group consisting of 1,4-phenylene, 1,3-phenylene, naphthylene, especially 2,7-dihydroxynaphthalene, and 4,4′-bisphenylene.

Units present with preference within the polyarylene ether are those which comprise at least one of the following repeat structural units (Va) to (Vo), wherein D has the same meaning as defined above:

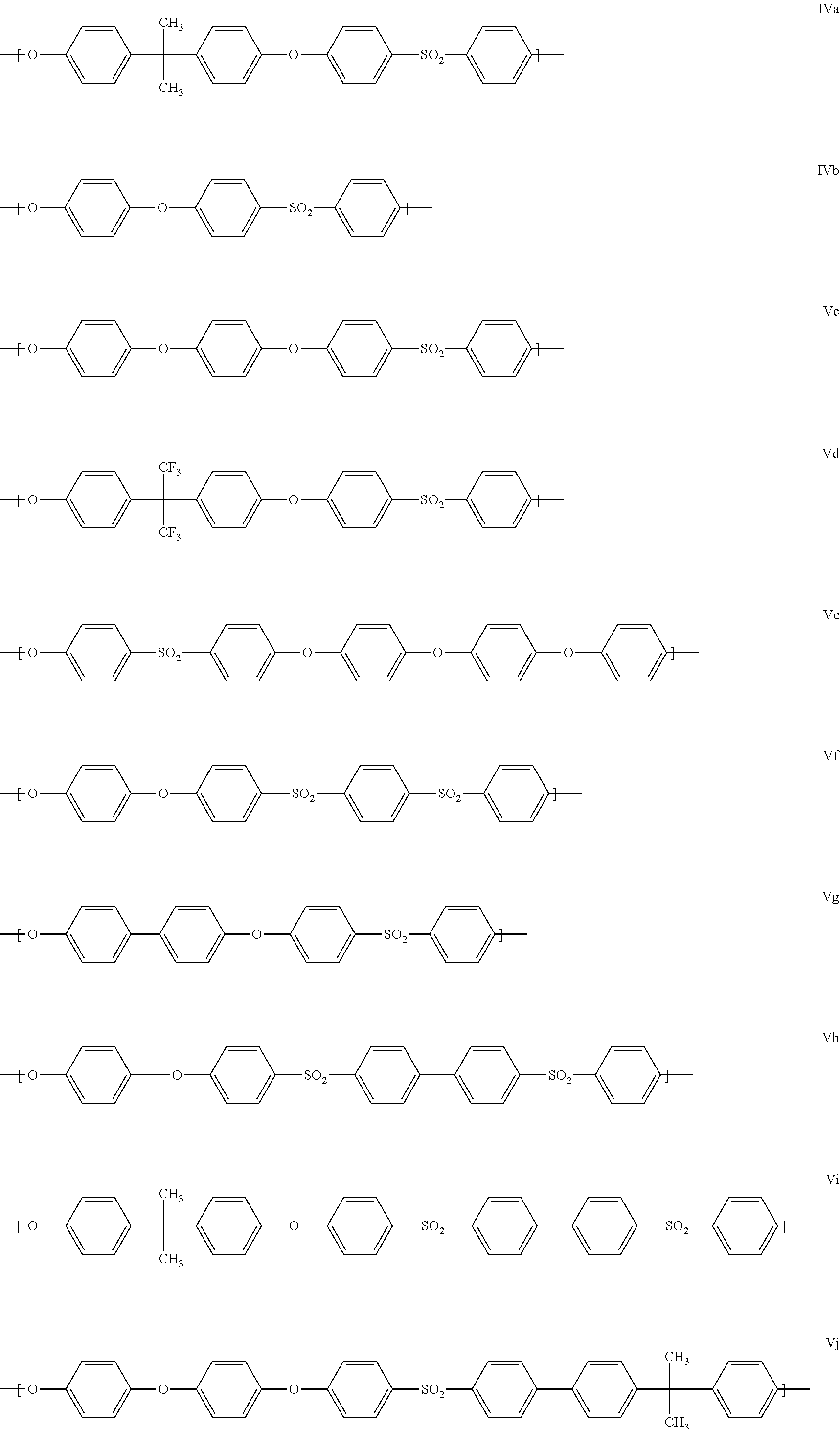

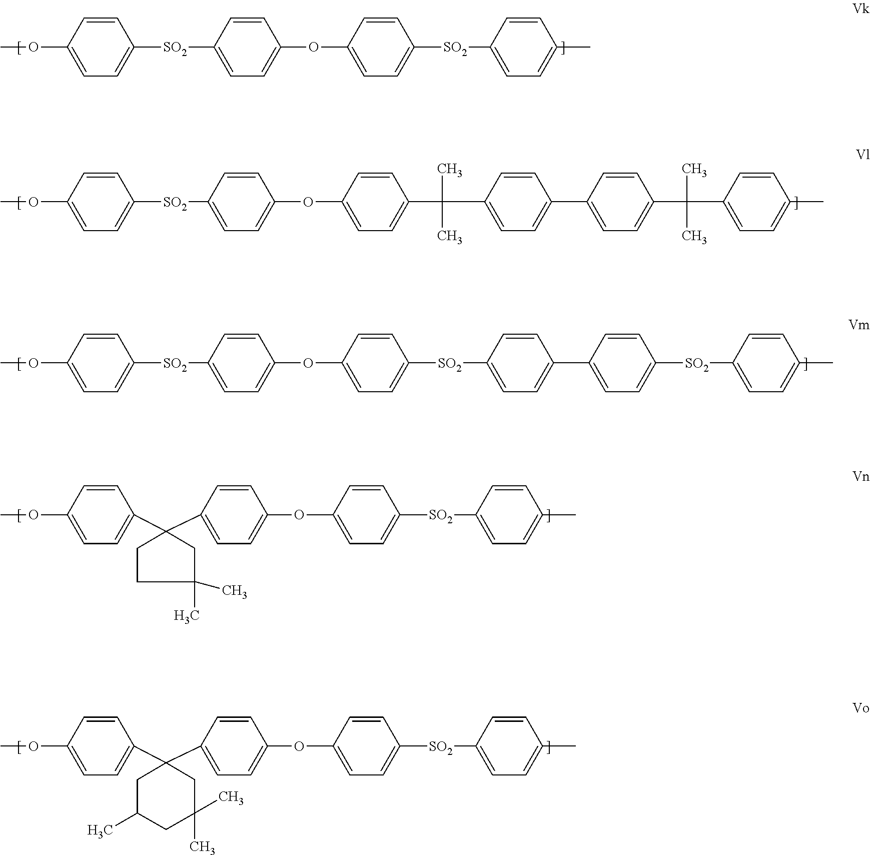

In addition to the units (Va) to (Vo) present with preference, preference is also given to those units in which one or more 1,4-dihydroxyphenyl units are replaced by resorcinol or dihydroxynaphthalene units.

Particularly preferred units of the general formula (V) are units (Va), (Vg) and (Vk). It is also particularly preferred when the polyarylene ether blocks are formed essentially from one kind of units of the general formula (V), especially from one unit selected from (Va), (Vg) and (Vk).

In a particularly preferred embodiment, Ar=1,4-phenylene, t=1, q=0, T=SO₂ and Y═SO₂. Such polyarylene ethers are referred to as polyether sulfone (PESU).

Suitable polyarylene ether blocks according to formula (V) preferably have a mean molecular weight Mn (number average) in the range from 1000 to 70000 g/mol, especially preferably 2000 to 40000 g/mol and particularly preferably 2500 to 30000 g/mol. The average molecular weight of the polyarylene ether blocks can be controlled and calculated by the ratio of the monomers forming the polyarylene ether blocks, as described by H. G. Elias in “An Introduction to Polymer Science” VCH Weinheim, 1997, p. 125.

In one embodiment, oligo- or polyurethanes U are poly(polydimethylsiloxane-block-co-polysulfonic)urethane derived from a polysulfone of formula

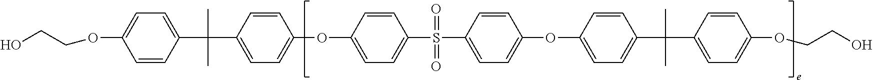

and polydimethylsiloxane of formula

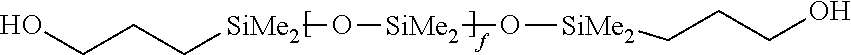

in a molar ratio ranging from 3:1 to 1:3, wherein e and f in both formulas is from the range 5 to 80, and 1,6-hexamethylene diisocyanate as linker.

In one embodiment, oligo- or polyurethanes U are poly(polydimethylsiloxane-block-co-polysulfonyl)urethane derived from a polysulfone of formula

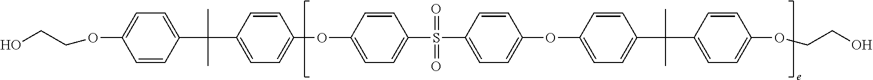

and polydimethylsiloxane of formula in

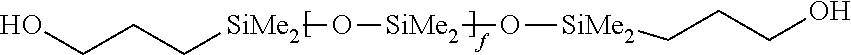

a molar ratio ranging from 3:1 to 1:3, wherein e and f in both formulas is from the range 5 to 80, and 1,6-hexamethylene diisocyanate as linker.

In one embodiment, oligo- or polyurethanes U are poly(polydimethylsiloxane-block-co-polysulfonyl)urethane derived from a polysulfone of formula

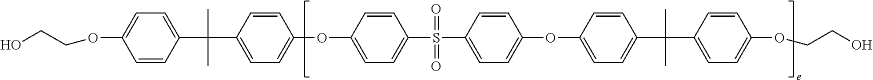

and polydimethylsiloxane of formula in

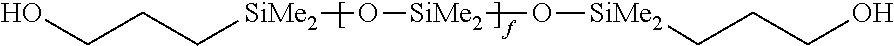

in a molar ratio ranging from 3:1 to 1:3, wherein e and f in both formulas is from the range 5 to 80, and 4,4′-methylenediphenyldiisocyanate as linker.

In one embodiment, oligo- or polyurethanes U are poly(polydimethylsiloxane-block-copolyethylenoxid-block-co-polysulfonyl)urethane derived from a polysulfone of formula

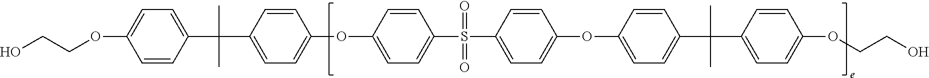

and polydimethylsiloxane of formula

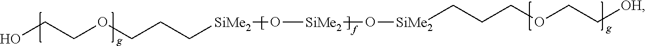

in a molar ratio ranging from 3:1 to 1:3, wherein e, f and g are from the range 5 to 80, and 4,4′-methylenediphenyldiisocyanate as linker.

In one embodiment, oligo- or polyurethanes U are poly(polydimethylsiloxane-block-copolyethylenoxid-block-co-polysulfonyl)urethane derived from a polysulfone of formula

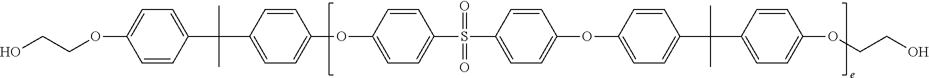

and polydimethylsiloxane of formula

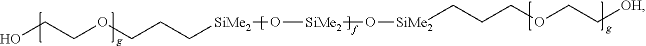

in a molar ratio ranging from 3:1 to 1:3, wherein e, f and g are from the range 5 to 80, and 4,4′-methylenediphenyldiisocyanate as linker.

In one embodiment, oligo- or polyurethanes U are poly(polydimethylsiloxane-block-copolyethylenoxid-block-co-polysulfonyl)urethane derived from a polysulfone of formula

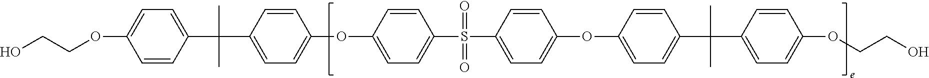

and polydimethylsiloxane of formula

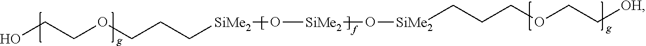

in a molar ratio ranging from 3:1 to 1:3, wherein e, f and g are from the range 5 to 80, and 1,6-hexamethylene diisocyanate as linker.

Another aspect of the present invention are processes for making oligo- or polyurethanes U, comprising the following steps:
a) reacting aromatic bishalogeno compounds and aromatic biphenols or salts thereof in the presence of at least one suitable base, wherein an excess of aromatic biphenols is used to obtain an OH-terminated polyarylene ether,
b) reacting the OH-terminated polyarylene ether obtained in step a) with ethylene carbonate
c) reacting the compound obtained in step b) with an aliphatic or aromatic diisocyanate linker
d) reacting the compound obtained in step c) with a linear oligo- or polysiloxane containing alkanol end groups, and optionally further containing one or more aliphatic ether moieties,
wherein step d) is carried after step c) and/or simultaneously with step c).

In step a) suitable polyarylene ethers are prepared, preferably polyarylene ethers according to formula (V). Such processes are in principle known to those skilled in the art and are not subject to any fundamental restriction, provided that the substituents mentioned are sufficiently reactive within a nucleophilic aromatic substitution.

Preferred starting compounds for making polyarylene ethers are difunctional. “Difunctional” means that the number of groups reactive in the nucleophilic aromatic substitution is two per starting compound. A further criterion for a suitable difunctional starting compound is a sufficient solubility in the solvent, as explained in detail below.

Preference is given to monomeric starting compounds, which means that the reaction is preferably performed proceeding from monomers and not proceeding from prepolymers.

The starting compound (M1) used is preferably a dihalodiphenyl sulfone. The starting compound (M2) used is preferably dihydroxydiphenyl sulfone.

Suitable starting compounds (M1) are especially dihalodiphenyl sulfones such as 4,4′-dichlorodiphenyl sulfone, 4,4′-difluorodiphenyl sulfone, 4,4′-dibromodiphenyl sulfone, bis(2-chlorophenyl) sulfones, 2,2′-dichlorodiphenyl sulfone and 2,2′-difluorodiphenyl sulfone, particular preference being given to 4,4′-dichlorodiphenyl sulfone and 4,4′-difluorodiphenyl sulfone.

Preferred compounds (M2) are accordingly those having two phenolic hydroxyl groups.

Phenolic OH groups are preferably reacted in the presence of a base in order to increase the reactivity toward the halogen substituents of the starting compound (M1).

Preferred starting compounds (M2) having two phenolic hydroxyl groups are selected from the following compounds:
dihydroxybenzenes, especially hydroquinone and resorcinol;
dihydroxynaphthalenes, especially 1,5-dihydroxynaphthalene, 1,6-dihydroxynaphthalene, 1,7-dihydroxynaphthalene, and 2,7-dihydroxynaphthalene;
dihydroxybiphenyls, especially 4,4′-biphenol and 2,2′-biphenol;
bisphenyl ethers, especially bis(4-hydroxyphenyl) ether and bis(2-hydroxyphenyl) ether;
bisphenylpropanes, especially 2,2-bis(4-hydroxyphenyl)propane, 2,2-bis(3-methyl-4-hydroxyphenyl)propane and 2,2-bis(3,5-dimethyl-4-hydroxyphenyl)propane;
bisphenylmethanes, especially bis(4-hydroxyphenyl)methane;
bisphenyl sulfones, especially bis(4-hydroxyphenyl) sulfone;
bisphenyl sulfides, especially bis(4-hydroxyphenyl) sulfide;
bisphenyl ketones, especially bis(4-hydroxyphenyl) ketone;
bisphenylhexafluoropropanes, especially 2,2-bis(3,5-dimethyl-4-hydroxyphenyl)hexafluoropropane; and
bisphenylfluorenes, especially 9,9-bis(4-hydroxyphenyl)fluorene;
1,1-Bis(4-hydroxyphenyl)-3,3,5-trimethyl-cyclohexane (bisphenol TMC).

It is preferable, proceeding from the aforementioned aromatic dihydroxyl compounds (M2), by addition of a base (B), to prepare the dipotassium or disodium salts thereof and to react them with the starting compound (M1). The aforementioned compounds can additionally be used individually or as a combination of two or more of the aforementioned compounds.

Hydroquinone, resorcinol, dihydroxynaphthalene, especially 2,7-dihydroxynaphthalene, bisphenol A, dihydroxydiphenyl sulfone and 4,4′-bisphenol are particularly preferred as starting compound (M2).

However, it is also possible to use trifunctional compounds. In this case, branched structures are the result. If a trifunctional starting compound (M2) is used, preference is given to 1,1,1-tris(4-hydroxyphenyl)ethane.

The ratios to be used derive in principle from the stoichiometry of the polycondensation reaction which proceeds with theoretical elimination of hydrogen chloride, and are established by the person skilled in the art in a known manner.

In a preferred embodiment, the ratio of halogen end groups to phenolic end groups is adjusted by controlled establishment of an excess of the dihydroxy starting compound (M2) in relation to a difunctional compound (M1) as starting compound.

More preferably, the molar (M2)/(M1) ratio in this embodiment is from 1.001 to 1.7, even more preferably from 1.003 to 1.5, especially preferably from 1.005 to 1.3, most preferably from 1.01 to 1.1.

In one embodiment, the molar ratio (M2)/(M1) is 1.000 to 1.35 or 1.005 to 1.25.

Alternatively, it is also possible to use a starting compound (M1) where X=halogen and Y═OH. In this case, the ratio of halogen to OH end groups used is preferably from 1.001 to 1.7, more preferably from 1.003 to 1.5, especially from 1.005 to 1.3, most preferably 1.01 to 1.251.

Preferably, the conversion in the polycondensation is at least 0.9, which ensures a sufficiently high molecular weight.

Solvents (L) preferred in the context of the present invention are organic, especially aprotic polar solvents. Suitable solvents also have a boiling point in the range from 80 to 320° C., especially 100 to 280° C. at atmospheric pressure, preferably from 150 to 250° C. Suitable aprotic polar solvents are, for example, high-boiling ethers, esters, ketones, asymmetrically halogenated hydrocarbons, anisole, dimethylformamide, dimethyl sulfoxide, sulfolane, N-methyl-2-pyrrolidone and/or N-ethyl-2-pyrrolidone. It is also possible to use mixtures of these solvents.

A preferred solvent L is especially N-methyl-2-pyrrolidone and/or N-ethyl-2-pyrrolidone, especially N-methyl-2-pyrrolidone.

Preferably, the starting compounds (M1) and (M2) are reacted in the aprotic polar solvents (L) mentioned, especially N-methyl-2-pyrrolidone.

In step b) polyarylene ethers obtained in step a) are at least partly etherified with at least one alkylene glycol, preferably ethylene glycol, by reaction with at least one alkylene carbonate, preferably ethylene carbonate. Preferably step b) is carried out such that at least 70% of the terminal position of the polyarylene ether obtained in step a) are etherified with one alkylene glycol. In this context, “reacting the OH-terminated polyarylene ether obtained in step a) with ethylene carbonate” shall also include the reaction of deprotonated OH-terminated polyarylene ether with ethylene carbonate.

In step c) the product obtained in step b) is reacted with at least one aliphatic or aromatic diisocyanate to yield arylene ether urethanes.

The urethane reaction applied in step c) is analogous to a reaction commonly used to build up a broad variety of polymers such as soft and hard polyurethanes in multiple applications and use.

Typically, the reaction is carried out in presence of aprotic none or less polar solvents and with the use of catalysts such as amines (imidazoles), tin organic compounds and others.

Suitable diisocyanates include tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethylbiphenyl diisocyanate, 1,2-diphenylethane diisocyanate and/or phenylene diisocyanate. Preference is given to using 4,4′-MDI. Preference is given to aliphatic diisocyanates, in particular HDI or IPDI, and particular preference is given to aromatic diisocyanates such as 2,4- and 2,6 TDI as well 2,2′-, 2,4′- and/or 4,4′-diphenylmethane diisocyanate (MDI) and mixtures of the aforementioned isomers.

Especially preferred isocyanates are HDI and MDI.

In step d) a linear oligo- or polysiloxane containing alkanol end groups, and optionally further containing one or more aliphatic ether moieties, is linked to the product in step b) and step c) via urethane groups.

Preferred oligo- or polysiloxanes containing alkanol end groups are those according to formula (IV) as defined above.

Step d) is normally carried out after step c) and/or at least partly simultaneously with step c).

Between each step a) to d), it may be necessary to carry out workup of the products obtained.

Another aspect of the present invention are polymer compositions comprising oligo- or polyurethanes U as well as one or more further organic polymer P selected from the group consisting of polyvinyl pyrrolidone, polyvinyl acetates, cellulose acetates, polyacrylonitriles, polyamides, polyolefines, polyesters, polyarylene ethers, polysulfones, polyethersulfones, polyphenylenesulfones, polycarbonates, polyether ketones, sulfonated polyether ketones, polyamide sulfones, polyvinylidene fluorides, polyvinylchlorides, polystyrenes and polytetrafluorethylenes, copolymers thereof, and mixtures thereof; preferably selected from the group consisting of polysulfones, polyethersulfones, polyvinylidene fluorides, polyamides, cellulose acetate and mixtures thereof.

In one preferred embodiment said one or more further polymer P is selected from polyvinyl pyrrolidone, polysulfones, polyethersulfones, polyphenylenesulfones, polyvinylidene fluorides, polyamides, cellulose acetate, copolymers thereof, and mixtures thereof; In an especially preferred embodiment said one or more further polymer P is selected from polysulfones, polyethersulfones, and polyphenylenesulfones.

Preferably, polymer compositions according to the invention comprise 0.1 to 25% by weight of oligo- or polyurethanes U and 75 to 99.1% by weight of one or more further polymer P.

In one embodiment polymer compositions according to the invention comprise 1 to 10% by weight of oligo- or polyurethanes U and 90 to 99% by weight of one or more further polymer P.

In one embodiment of the invention, polymer compositions according to the invention further comprise one or more antimicrobial or bacteriostatic agents, especially silver in ionic and/or metallic form such as silver colloid, silver glass, silver zeolite, silver salts or elemental silver in form of powder, microparticle, nanoparticle or cluster. Such antimicrobial or bacteriostatic agents are usually comprised in polymer compositions according to the invention in amounts from 0.05 to 5.0% by weight.

Another aspect of the present invention are membranes comprising oligo- or polyurethanes U and/or polymer compositions according to the invention.

The present oligo- or polyurethanes U and polymer compositions according to the invention are in one embodiment used as anti-adhesion additives in polymer compositions, such as compositions for membranes, especially water processing or gas separation membranes.

In the context of this application a membrane shall be understood to be a thin, semipermeable structure capable of separating two fluids or separating molecular and/or ionic components or particles from a liquid. A membrane acts as a selective barrier, allowing some particles, substances or chemicals to pass through, while retaining others.

The process for preparing membranes according the invention generally comprises incorporation of the above oligo- or polyurethanes U, a further polymer as noted under component (b) of polymer compositions according to the invention, and optionally further additives into the membrane material.

For example, membranes according to the invention can be reverse osmosis (RO) membranes, forward osmosis (FO) membranes, nanofiltration (NF) membranes, ultrafiltration (UF) membranes or microfiltration (MF) membranes. These membrane types are generally known in the art and are further described below.

FO membranes are normally suitable for treatment of seawater, brackish water, sewage or sludge streams. Thereby pure water is removed from those streams through a FO membrane into a so called draw solution on the back side of the membrane having a high osmotic pressure.

In a preferred embodiment, suitable FO membranes are thin film composite (TFC) FO membranes. Preparation methods and use of thin film composite membranes are principally known and, for example described by R. J. Petersen in Journal of Membrane Science 83 (1993) 81-150.

In a particularly preferred embodiment, suitable FO membranes comprise a fabric layer, a support layer, a separation layer and optionally a protective layer. Said protective layer can be considered an additional coating to smoothen and/or hydrophilize the surface.

Said fabric layer can for example have a thickness of 10 to 500 μm. Said fabric layer can for example be a woven or nonwoven, for example a polyester nonwoven.

Said support layer of a TFC FO membrane normally comprises pores with an average pore diameter of for example 0.5 to 100 nm, preferably 1 to 40 nm, more preferably 5 to 20 nm. Said support layer can for example have a thickness of 5 to 1000 μm, preferably 10 to 200 μm. Said support layer may for example comprise as the main component a polysulfone, polyethersulfone, polyphenylenesulfone, polyvinylidenedifluoride PVDF, polyimide, polyimideurethane or cellulose acetate.

In a preferred embodiment, FO membranes comprise a support layer comprising as the main component polymer compositions according to the invention.

In another embodiment, FO membranes comprise a support layer comprising as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone (PSU), polyphenylenesulfone (PPSU) or polyethersulfone (PESU) different from oligo- or polyurethanes U, or mixtures thereof in combination with at least one oligo- or polyurethane U.

In another preferred embodiment, FO membranes comprise a support layer comprising as the main components at least one polysulfone, polyphenylenesulfone and/or polyethersulfone different from block copolymers described above in combination with at least one oligo- or polyurethane U.

Nano particles such as zeolites, may be comprised in said support membrane. This can for example be achieved by including such nano particles in the dope solution for the preparation of said support layer.

Said separation layer of a FO membrane can for example have a thickness of 0.05 to 1 μm, preferably 0.1 to 0.5 μm, more preferably 0.15 to 0.3 μm. Preferably said separation layer can for example comprise polyamide or cellulose acetate as the main component.

Optionally, TFC FO membranes can comprise a protective layer with a thickness of 30-500 preferable 100-300 nm. Said protective layer can for example comprise polyvinylalcohol (PVA) as the main component. In one embodiment, the protective layer comprises a halamine like chloramine.

In one preferred embodiment, suitable membranes are TFC FO membranes comprising a support layer comprising block copolymers according to the invention, a separation layer comprising polyamide as main component and optionally a protective layer comprising polyvinylalcohol as the main component.

In a preferred embodiment suitable FO membranes comprise a separation layer obtained from the condensation of a polyamine and a polyfunctional acyl halide. Said separation layer can for example be obtained in an interfacial polymerization process.

RO membranes are normally suitable for removing molecules and ions, in particular monovalent ions. Typically, RO membranes are separating mixtures based on a solution/diffusion mechanism.

In a preferred embodiment, suitable membranes are thin film composite (TFC) RO membranes. Preparation methods and use of thin film composite membranes are principally known and, for example described by R. J. Petersen in Journal of Membrane Science 83 (1993) 81-150.

In a further preferred embodiment, suitable RO membranes comprise a fabric layer, a support layer, a separation layer and optionally a protective layer. Said protective layer can be considered an additional coating to smoothen and/or hydrophilize the surface

Said fabric layer can for example have a thickness of 10 to 500 μm. Said fabric layer can for example be a woven or nonwoven, for example a polyester nonwoven.

Said support layer of a TFC RO membrane normally comprises pores with an average pore diameter of for example 0.5 to 100 nm, preferably 1 to 40 nm, more preferably 5 to 20 nm. Said support layer can for example have a thickness of 5 to 1000 μm, preferably 10 to 200 μm. Said support layer may for example comprise as main component a polysulfone, polyethersulfone, polyphenylenesulfone, PVDF, polyimide, polyimideurethane or cellulose acetate.

In a preferred embodiment, RO membranes comprise a support layer comprising as the main component polymer compositions according to the invention.

In another embodiment, RO membranes comprise a support layer comprising as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone different from oligo- or polyurethanes U, or mixtures thereof in combination with at least one oligo- or polyurethane U.

In another preferred embodiment, RO membranes comprise a support layer comprising as the main component at least one polysulfone, polyphenylenesulfone and/or polyethersulfone different from oligo- or polyurethanes U in combination with at least one oligo- or polyurethane U.

Nano particles such as zeolites, may be comprised in said support membrane. This can for example be achieved by including such nano particles in the dope solution for the preparation of said support layer.

Said separation layer can for example have a thickness of 0.02 to 1 μm, preferably 0.03 to 0.5 μm, more preferably 0.05 to 0.3 μm. Preferably, said separation layer can for example comprise polyamide or cellulose acetate as the main component.

Optionally, TFC RO membranes can comprise a protective layer with a thickness of 5 to 500 preferable 10 to 300 nm. Said protective layer can for example comprise polyvinylalcohol (PVA) as the main component. In one embodiment, the protective layer comprises a halamine like chloramine.

In one preferred embodiment, suitable membranes are TFC RO membranes comprising a nonwoven polyester fabric, a support layer comprising block copolymers according to the invention, a separation layer comprising polyamide as main component and optionally a protective layer comprising polyvinylalcohol as the main component.

In a preferred embodiment suitable RO membranes comprise a separation layer obtained from the condensation of a polyamine and a polyfunctional acyl halide. Said separation layer can for example be obtained in an interfacial polymerization process.

Suitable polyamine monomers can have primary or secondary amino groups and can be aromatic (e. g. a diaminobenzene, a triaminobenzene, m-phenylenediamine, p-phenylenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e. g. ethylenediamine, propylenediamine, piperazine, and tris(2-diaminoethyl)amine).

Suitable polyfunctional acyl halides include trimesoyl chloride (TMC), trimellitic acid chloride, isophthaloyl chloride, terephthaloyl chloride and similar compounds or blends of suitable acyl halides. As a further example, the second monomer can be a phthaloyl halide.

In one embodiment of the invention, a separation layer of polyamide is made from the reaction of an aqueous solution of meta-phenylene diamine MPD with a solution of trimesoyl chloride (TMC) in an apolar solvent.

NF membranes are normally especially suitable for removing multivalent ions and large monovalent ions. Typically, NF membranes function through a solution/diffusion or/and filtration-based mechanism.

NF membranes are normally used in crossflow filtration processes.

In one embodiment of the invention NF membranes comprise polymer compositions according to the invention as the main component.

In another embodiment, NF membranes comprise as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, Poly(dimethylphenylene oxide) (PPO), Polycarbonate, Polyester, Polytetrafluroethylene (PTFE), Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone different from oligo- or polyurethanes U, or mixtures thereof in combination with one or more oligo- or polyurethane U.

In another embodiment of the invention, NF membranes comprise as the main component at least one polysulfone, polyphenylenesulfone and/or polyethersulfone different from oligo- or polyurethanes U in combination with one or more oligo- or polyurethane U.

In a particularly preferred embodiment, the main components of a NF membrane are positively or negatively charged.

Nanofiltration membranes often comprise charged polymers comprising sulfonic acid groups, carboxylic acid groups and/or ammonium groups in combination with block copolymers according to the invention.

In another embodiment, NF membranes comprise as the main component polyamides, poly-imides or polyimide urethanes, Polyetheretherketone (PEEK) or sulfonated polyetheretherketone (SPEEK), in combination with one or more oligo- or polyurethane U.

UF membranes are normally suitable for removing suspended solid particles and solutes of high molecular weight, for example above 10000 Da. In particular, UF membranes are normally suitable for removing bacteria and viruses.

UF membranes normally have an average pore diameter of 2 nm to 50 nm, preferably 5 to 40 nm, more preferably 5 to 20 nm.

In one embodiment of the invention UF membranes comprise polymer compositions according to the invention as the main component.

In another embodiment, UF membranes comprise as the main component at least one polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone, or polyethersulfone different from oligo- or polyurethanes U, or mixtures thereof in combination with one or more oligo- or polyurethane U.

In another embodiment of the invention, UF membranes comprise as the main component at least one polysulfone, polyphenylenesulfone and/or polyethersulfone different from oligo- or polyurethanes U in combination with one or more oligo- or polyurethane U.

In one preferred embodiment, oligo- or polyurethanes U are used to make UF membranes, wherein oligo- or polyurethanes U are comprised in such UF membranes an amount from 0.1 to 25% by weight, preferably 1 to 10% by weight.

In one embodiment, UF membranes comprise further additives like polyvinyl pyrrolidones or polyalkylene oxides like polyethylene oxides.

In a preferred embodiment, UF membranes comprise as major components polysulfones, polyphenylenesulfone or polyethersulfone different from oligo- or polyurethanes U in combination with at least one oligo- or polyurethane U and with further additives like polyvinylpyrrolidone.

In one preferred embodiment, UF membranes comprise 99.9 to 50% by weight of a combination of polyethersulfone different from oligo- or polyurethane U and one or more oligo- or polyurethane U and 0.1 to 50% by weight of polyvinylpyrrolidone.

In another embodiment UF membranes comprise 95 to 80% by weight of polyethersulfone different from oligo- or polyurethane U and one or more oligo- or polyurethane U and 5 to 15% by weight of polyvinylpyrrolidone.

In one embodiment of the invention, UF membranes are present as spiral wound membranes, as pillows or flat sheet membranes.

In another embodiment of the invention, UF membranes are present as tubular membranes.

In another embodiment of the invention, UF membranes are present as hollow fiber membranes or capillaries.

In yet another embodiment of the invention, UF membranes are present as single bore hollow fiber membranes.

In yet another embodiment of the invention, UF membranes are present as multibore hollow fiber membranes.

Multiple channel membranes, also referred to as multibore membranes, comprise more than one longitudinal channels also referred to simply as “channels”.

In a preferred embodiment, the number of channels is typically 2 to 19. In one embodiment, multiple channel membranes comprise two or three channels. In another embodiment, multiple channel membranes comprise 5 to 9 channels. In one preferred embodiment, multiple channel membranes comprise seven channels.

In another embodiment the number of channels is 20 to 100.

The shape of such channels, also referred to as “bores”, may vary. In one embodiment, such channels have an essentially circular diameter. In another embodiment, such channels have an essentially ellipsoid diameter. In yet another embodiment, channels have an essentially rectangular diameter.

In some cases, the actual form of such channels may deviate from the idealized circular, ellipsoid or rectangular form.

Normally, such channels have a diameter (for essentially circular diameters), smaller diameter (for essentially ellipsoid diameters) or smaller feed size (for essentially rectangular diameters) of 0.05 mm to 3 mm, preferably 0.5 to 2 mm, more preferably 0.9 to 1.5 mm. In another preferred embodiment, such channels have a diameter (for essentially circular diameters), smaller diameter (for essentially ellipsoid diameters) or smaller feed size (for essentially rectangular diameters) in the range from 0.2 to 0.9 mm.

For channels with an essentially rectangular shape, these channels can be arranged in a row.

For channels with an essentially circular shape, these channels are in a preferred embodiment arranged such that a central channel is surrounded by the other channels. In one preferred embodiment, a membrane comprises one central channel and for example four, six or 18 further channels arranged cyclically around the central channel.

The wall thickness in such multiple channel membranes is normally from 0.02 to 1 mm at the thinnest position, preferably 30 to 500 μm, more preferably 100 to 300 μm.

Normally, the membranes according to the invention and carrier membranes have an essentially circular, ellipsoid or rectangular diameter. Preferably, membranes according to the invention are essentially circular.

In one preferred embodiment, membranes according to the invention have a diameter (for essentially circular diameters), smaller diameter (for essentially ellipsoid diameters) or smaller feed size (for essentially rectangular diameters) of 2 to 10 mm, preferably 3 to 8 mm, more preferably 4 to 6 mm.

In another preferred embodiment, membranes according to the invention have a diameter (for essentially circular diameters), smaller diameter (for essentially ellipsoid diameters) or smaller feed size (for essentially rectangular diameters) of 2 to 4 mm.

In one embodiment the rejection layer is located on the inside of each channel of said multiple channel membrane.

In one embodiment, the channels of a multibore membrane may incorporate an active layer with a pore size different to that of the carrier membrane or a coated layer forming the active layer. Suitable materials for the coated layer are polyoxazoline, polyethylene glycol, polystyrene, hydrogels, polyamide, zwitterionic block copolymers, such as sulfobetaine or carboxybetaine. The active layer can have a thickness in the range from 10 to 500 nm, preferably from 50 to 300 nm, more preferably from 70 to 200 nm.

In one embodiment multi bore membranes are designed with pore sizes between 0.2 and 0.01 μm. In such embodiments the inner diameter of the capillaries can lie between 0.1 and 8 mm, preferably between 0.5 and 4 mm and particularly preferably between 0.9 and 1.5 mm. The outer diameter of the multi bore membrane can for example lie between 1 and 26 mm, preferred 2.3 and 14 mm and particularly preferred between 3.6 and 6 mm. Furthermore, the multi bore membrane can contain 2 to 94, preferably 3 to 19 and particularly preferred between 3 and 14 channels. Often multi bore membranes contain seven channels. The permeability range can for example lie between 100 and 10000 L/m²hbar, preferably between 300 and 2000 L/m²hbar.

Typically multi bore membranes of the type described above are manufactured by extruding a polymer, which forms a semi-permeable membrane after coagulation through an extrusion nozzle with several hollow needles. A coagulating liquid is injected through the hollow needles into the extruded polymer during extrusion, so that parallel continuous channels extending in extrusion direction are formed in the extruded polymer. Preferably the pore size on an outer surface of the extruded membrane is controlled by bringing the outer surface after leaving the extrusion nozzle in contact with a mild coagulation agent such that the shape is fixed without active layer on the outer surface and subsequently the membrane is brought into contact with a strong coagulation agent. As a result a membrane can be obtained that has an active layer inside the channels and an outer surface, which exhibits no or hardly any resistance against liquid flow. Herein suitable coagulation agents include solvents and/or non-solvents. The strength of the coagulations may be adjusted by the combination and ratio of non-solvent/solvent. Coagulation solvents are known to the person skilled in the art and can be adjusted by routine experiments. An example for a solvent based coagulation agent is N-methylpyrrolidone. Non-solvent based coagulation agents are for instance water, iso-propanol and propylene glycol.

Manufacturing of ultrafiltration membranes often includes non-solvent induced phase separation (NIPS). The present copolymers are preferably employed as additives in this process.

In the NIPS process, the polymers used as starting materials (e.g. selected from polyvinyl pyrrolidone, vinyl acetates, cellulose acetates, polyacrylonitriles, polyamides, polyolefines, polyesters, polysulfones, polyethersulfones, polycarbonates, polyether ketones, sulfonated polyether ketones, polyamide sulfones, polyvinylidene fluorides, polyvinylchlorides, polystyrenes and polytetrafluorethylenes, copolymers thereof, and mixtures thereof; preferably selected from the group consisting of polysulfones, polyethersulfones, polyphenylene sulfones, polyvinylidene fluorides, polyamides, cellulose acetate and mixtures thereof, especially including poly ether sulfone) are dissolved in a suitable solvent (e.g. N-methylpyrrolidone, dimethylacetamide or dimethylsulfoxide) together with any additive(s) used, including one or more oligo- or polyurethane U. In a next step, a porous polymeric membrane is formed under controlled conditions in a coagulation bath. In most cases, the coagulation bath contains water as coagulant, or the coagulation bath is an aqueous medium, wherein the matrix forming polymer is not soluble. The cloud point of the polymer is defined in the ideal ternary phase diagram. In a bimodal phase separation, a microscopic porous architecture is then obtained, and water soluble components (including polymeric additives) are finally found in the aqueous phase.

In case that the polymeric additive is simultaneously compatible with the coagulant and the matrix polymer(s), segregation on the surface results. With the surface segregation, an enrichment of the certain additives like oligo- or polyurethanes U is observed. The membrane surface thus offers new (hydrophilic) properties compared to the primarily matrix-forming polymer, the phase separation induced enrichment of the additive of the invention leading to antiadhesive surface structures.

An important property of the novel surface modifying additive is the formation of a dense coverage combined with a strong anchoring effect to the polymeric matrix.

In many cases, a surface structure is obtained by micro-structured self-assembling monolayers (SAM), which hinder the adhesion of microbes.

A typical process for the preparation of a solution to prepare membranes is characterized by the following steps:
1. Solving matrix polymers for a membrane's dope in a suitable solvent, typically NMP, DMA, DMSO or mixtures of them.
2. Adding pore forming additives such as PVP, PEG, sulfonated PES or mixtures of them
3. Heating the mixtures until a viscous solution is obtained; typically temperatures of 5-250° C., preferred 25-150° C., mostly preferred 50-90° C.
4. Adding one or more oligo- or polyurethane U to the dope at 5-250° C., preferred 25-150° C., and mostly preferred 50-90° C. Optionally other additives e.g. silver containing compounds may be added in the same step.
5. Stirring of the solution/suspension until a mixture is formed within 1-15 h, typically the homogenization is finalized within 2 h.
6. Casting the membrane dope in a coagulation bath to obtain a membrane structure. Optionally the casting could be outlined using a polymeric support (non-woven) for stabilizing the membrane structure mechanically. To test the bioactivity for the application a standard procedure in flat membrane fabrication is used.
7. Analysis of the membrane for the content of oligo- or polyurethanes U.

MF membranes are normally suitable for removing particles with a particle size of 0.1 μm and above.

MF membranes normally have an average pore diameter of 0.05 μm to 10 μm, preferably 0.1 μm to 5 μm.

Microfiltration can use a pressurized system but it does not need to include pressure.

MF membranes can be capillaries, hollow fibers, flat sheet, tubular, spiral wound, pillows, hollow fine fiber or track etched. They are porous and allow water, monovalent species (Na+, Cl−), dissolved organic matter, small colloids and viruses through but retain particles, sediment, algae or large bacteria.

Microfiltration systems are designed to remove suspended solids down to 0.1 micrometers in size, in a feed solution with up to 2-3% in concentration.

In one embodiment of the invention MF membranes comprise polymer compositions according to the invention as the main component.

In another embodiment, MF membranes comprise as the main component at least polyamide (PA), polyvinylalcohol (PVA), Cellulose Acetate (CA), Cellulose Triacetate (CTA), CA-triacetate blend, Cellulose ester, Cellulose Nitrate, regenerated Cellulose, aromatic, aromatic/aliphatic or aliphatic Polyamide, aromatic, aromatic/aliphatic or aliphatic Polyimide, Polybenzimidazole (PBI), Polybenzimidazolone (PBIL), Polyacrylonitrile (PAN), PAN-poly(vinyl chloride) copolymer (PAN-PVC), PAN-methallyl sulfonate copolymer, Poly(dimethylphenylene oxide) (PPO), Polycarbonate, Polyester, Polytetrafluroethylene PTFE, Poly(vinylidene fluoride) (PVDF), Polypropylene (PP), Polyelectrolyte complexes, Poly(methyl methacrylate) PMMA, Polydimethylsiloxane (PDMS), aromatic, aromatic/aliphatic or aliphatic polyimide urethanes, aromatic, aromatic/aliphatic or aliphatic polyamidimides, crosslinked polyimides or polyarylene ether, polysulfone, polyphenylenesulfone or polyethersulfone different from oligo- or polyurethanes U, or mixtures thereof in combination with one or more oligo- or polyurethane U.

In another embodiment of the invention, MF membranes comprise as the main component at least one polysulfone, polyphenylenesulfone and/or polyethersulfone different from oligo- or polyurethanes U in combination with one or more oligo- or polyurethane U.

In one preferred embodiment, block copolymers according to the invention are used to make MF membranes, wherein one or more oligo- or polyurethane U are comprised in an amount from 0.1 to 25% by weight, preferably 1 to 10% by weight.

Membranes according to the invention, especially UF and MF membranes or the support layer of RO or FO membranes in one embodiment consist essentially of a polymer composition comprising one or more oligo- or polyurethane U in an amount of 0.1 to 25% by weight of the total polymer composition, especially in a homogenous phase or within the same phase enriched at the surface. It may further comprise one or more antimicrobial or bacteriostatic agents, especially silver in ionic and/or metallic form such as silver colloid, silver glass, silver zeolite, silver salts or elemental silver in form of powder, microparticle, nanoparticle or cluster in an amount of typically 0.0001 to 1% by weight. Membranes according to the invention often show an at least 4-fold enrichment of silicon, especially a 5- to 25-fold enrichment of silicon, in the section 2-10 nm from the membrane surface over the membrane's average silicon content.

In order to quantify the amount of copolymer on the membrane surface and the enrichment of silicon on the surface, the content of Silicon on the surface is determined by XPS-analysis. The penetration depth of this method is considered to be 2-10 nm, hence only the composition of the active surface in membranes can be detected. Measurements lead to the composition of the surface in atom-% which can then be transferred into wt.-%. The overall content of Silicon in the membranes can be determined by dissolving a piece of the membrane in CDCl3 and running a ¹H-NMR spectra of this solution. By integration of the signal for the Si(CH₃)₂-units the content of Siloxane-units in the whole sample can be determined. From this the overall content of Silicon in the samples can be calculated. The enrichment factor is then defined as the ratio between the Si-content at surface divided by the Si-content of the overall sample.

Membranes according to the invention have a high flexibility.

Membranes according to the invention have a high upper glass transition temperature.

Membranes according to the invention are easy to make and to handle, are able to stand high temperatures and can for example be subjected to vapor sterilization.

Furthermore, membranes according to the invention have very good dimensional stabilities, high heat distortion resistance, good mechanical properties and good flame retardance properties and biocompatibility. They can be processed and handled at high temperatures, enabling the manufacture of membranes and membrane modules that are exposed to high temperatures and are for example subjected to disinfection using steam, water vapor or higher temperatures, for example above 100° C. of above 125° C.

Membranes according to invention show excellent properties with respect to the decrease of flux through a membrane over time and their fouling and biofouling properties.

Membranes according to the invention are easy and economical to make.

Filtration systems and membranes according to invention can be made using aqueous or alcoholic systems and are thus environmentally friendly. Furthermore, leaching of toxic substances is not problematic with membranes according to the invention.

Membranes according to the invention have a long lifetime.

Another aspect of the invention are membrane elements comprising a polymer composition or membrane according to the invention.

A “membrane element”, herein also referred to as a “filtration element”, shall be understood to mean a membrane arrangement of at least one single membrane body. A filtration element can either be directly used as a filtration module or be included in a membrane module. A membrane module, herein also referred to as a filtration module, comprises at least one filtration element. A filtration module normally is a ready to use part that in addition to a filtration element comprises further components required to use the filtration module in the desired application, such as a module housing and the connectors. A filtration module shall thus be understood to mean a single unit which can be installed in a membrane system or in a membrane treatment plant. A membrane system herein also referred to as a filtration system is an arrangement of more than one filtration module that are connected to each other. A filtration system is implemented in a membrane treatment plant.

In many cases, filtration elements comprise more than one membrane arrangement and may further comprise more components like an element housing, one or more bypass tubes, one or more baffle plates, one or more perforated inner tubes or one or more filtrate collection tube. For hollow fiber or multibore membranes, for example, a filtration element normally comprises more than one hollow fiber or multibore membrane arrangement that have been fixed to an outer shell or housing by a potting process. Filtration elements that have been subjected to potting can be fixed on one end or on both ends of the membrane arrangement to the outer shell or housing.

In one embodiment, filtration elements or filtration modules according to the invention discharge permeate directly through an opening in the tube housing or indirectly through a discharge tube located within the membrane element. Particularly when indirect discharge is facilitated the discharge tube can for example be placed in the center of the membrane element and the capillaries of the membrane element are arranged in bundles surrounding the discharge tube.

In another embodiment, a filtration element for filtering comprises an element housing, wherein at least one membrane arrangement and at least one permeate collecting tube are arranged within the element housing and wherein the at least one permeate collecting tube is arranged in an outer part of the filtration element.

The permeate collecting tube inside filtration elements or filtration modules may in one embodiment have cylindrical shape, wherein the cross-section may have any shape such as round, oval, triangular, square or some polygon shape. Preferred is a round shape, which leads to enhanced pressure resistance. Preferably the longitudinal center line of the at least one permeate collecting tube is arranged parallel to the longitudinal center line of the membrane element and the element housing. Furthermore, a cross-section of the permeate collecting tube may be chosen according to the permeate volume produced by the membrane element and pressure losses occurring in the permeate collecting tube. The diameter of the permeate collecting tube may be less than half, preferred less than a third and particularly preferred less than a quarter of the diameter of the element housing.

The permeate collecting tube and the membrane element may have different or the same shape. Preferably the permeate collecting tube and the membrane element have the same shape, particularly a round shape. Thus, the at least one permeate collecting tube can be arranged within the circumferential ring extending from the radius of the element housing to half, preferred a third and particularly preferred a quarter of the radius of the element housing.

In one embodiment the permeate collecting tube is located within the filtration element such that the permeate collecting tube at least partially touches the element housing. This allows placing the filtration element in the filtration module or system such that the permeate collecting tube is arranged substantially at the top of the filtration element in horizontal arrangement. In this context substantially at the top includes any position in the outer part of the membrane that lies within ±45°, preferred ±10° from a vertical center axis in a transverse plane of the filtration element. Here the vertical center axis in a transverse plane is perpendicular to the horizontal center axis in the transverse plane and to the longitudinal center axis extending along the long axis of the filtration element. By arranging the permeate collecting tube this way, air residing within the membrane element before start-up of the filtration module or system can be collected in the permeate collecting tube, which can then easily be vented upon start up by starting the filtration operation. In particular, air pockets can be displaced by permeate which is fed to the filtration module or system and filtered by the membrane element on start up. By releasing air from the filtration module or system the active area of the membrane element increases, thus increasing the filtering effect. Furthermore the risk of fouling due to trapped air pockets decreases and pressure surges as well as the risk of breakage of the membrane element are minimized.

In another embodiment of the filtration element at least two permeate collecting tubes may be arranged in the filtration element, particularly within the element housing. By providing more than one permeate collecting tube the output volume of permeate at a constant pressure can be increased and adjusted to the permeate volume produced by the membrane element. Furthermore the pressure loss is reduced if high backwashing flows are required. Here at least one first permeate collecting tube is arranged in the outer part of the filtration element and at least one second permeate collecting tube can be arranged in the inner or the outer part of the filtration element. For example, two permeate collecting tubes may be arranged in the outer part or one first permeate collecting tube may be arranged in the outer part and another second permeate collecting tube may be arranged in the inner part of the filtration element.

Preferably at least two permeate collecting tubes are arranged opposite each other in the outer part or the outer circumferential ring of the filtration element. By providing at least two permeate collecting tubes opposite each other in the outer part of the filtration element, the filtration element can be placed in a filtration module or system such that one of the tubes are arranged substantially at the top of the element while the other tube is arranged substantially at the bottom. This way ventilation can be achieved through the top tube, while the additional bottom tube increases output volume at a constant pressure.

In another embodiment the filtration element further comprises a perforated tube arranged around the membrane element, in particular composing at least one membrane arrangement comprising at least one hollow fiber membrane. The perforations may be formed by holes or other openings located in regular or irregular distances along the tube. Preferably, the membrane element, in particular the membrane arrangement is enclosed by the perforated tube. With the perforated tube the axial pressure distribution along the filtration element can be equalized in filtration and back washing operation. Thus, the permeate flow is evenly distributed along the filtration element and hence the filtering effect can be increased.

In another embodiment the perforated tube is arranged such that an annular gap is formed between the element housing and the perforated tube. Known membrane elements do not have a distinct border and the membrane element are directly embedded in a housing of the filtration element. This leads to an uneven pressure distribution in axial direction as the axial flow is disturbed by the membrane element.

In another embodiment the membrane element comprises multibore membranes. The multi bore membranes preferably comprise more than one capillary, which runs in a channel along the longitudinal axis of the membrane element or the filtration element. Particularly, the multi bore membrane comprises at least one substrate forming the channels and at least one active layer arranged in the channels forming the capillaries. Embedding the capillaries within a substrate allows forming a multi bore membrane, which are considerably easier to mount and mechanically more stable than membranes based on single hollow fibers. As a result of the mechanical stability, the multi bore membrane is particularly suitable for cleaning by back washing, where the filtration direction is reversed such that a possible fouling layer formed in the channels is lifted and can be removed. In combination with the arrangements of the permeate collecting tube leading to an even pressure distribution within the membrane element, the overall performance and stability of the filtration element is further enhanced.

In contrast to designs with a central discharge tube and single bore membranes, the distribution of the multi bore membranes is advantageous in terms of producing lower pressure loss in both operational modes filtration and backwash. Such designs further increases stability of the capillaries by equalizing the flow or pressure distribution across the membrane element. Thus, such designs avoid adverse effects on the pressure distribution among the capillaries of the membrane element. For designs with a central permeate collecting tube permeate flows in filtration mode from the outer capillaries of the membrane to the inner capillaries and has to pass a decreasing cross-section. In backwashing mode the effect reverses in that sense, that the flow volume decreases towards the outer capillaries and thus the cleaning effect decreases towards the outside as well. In fact the uneven flow and pressure distribution within the membrane element leads to the outer capillaries having a higher flow in filtration mode and hence building up more fouling layer than the inner capillaries. In backwashing mode, however, this reverses to the contrary with a higher cleaning effect for the inner capillaries, while the outer exhibit a higher build up. Thus the combination of the permeate collecting tube in the outer part of the filtration element and the use of the multi-bore membrane synergistically lead to a higher long-term stability of the filtration element.

Another aspect of the invention are membrane modules comprising membranes or membrane elements according to the invention.

In one embodiment, membrane modules according to the invention comprise a filtration element which is arranged within a module housing. The raw water is at least partly filtered through the filtration element and permeate is collected inside the filtration module and removed from the filtration module through an outlet. In one embodiment the filtrate (also referred to as “permeate”) is collected inside the filtration module in a permeate collection tube. Normally the element housing, optionally the permeate collecting tube and the membrane arrangement are fixed at each end in membrane holders comprising a resin, preferably an epoxy resin, in which the filtration element housing, the membranes, preferably multibore membranes, and optionally the filtrate collecting tube are embedded.

Membrane modules can in one embodiment for example have cylindrical shape, wherein the cross-section can have any shape such as round, oval, triangular, square or some polygon shape. Preferred is a round shape, which leads to a more even flow and pressure distribution within the membrane element and avoids collection of filtered material in certain areas such as corners for e.g. square or triangular shapes.

In one embodiment, membrane modules according to the invention have an inside-out configuration (“inside feed”) with the filtrate flowing from the inside of a hollow fiber or multibore membrane to the outside.

In one embodiment, membrane modules according to the invention have an outside-in filtration configuration (“outside feed”).

In a preferred embodiment, membranes, filtration elements, filtration modules and filtration systems according to the invention are configured such that they can be subjected to backwashing operations, in which filtrate is flushed through membranes in opposite direction to the filtration mode.

In one embodiment, membrane modules according to the invention are encased.

In another embodiment, membrane modules according to the invention are submerged in the fluid that is to be subjected to filtration.

In one embodiment, membranes, filtration elements, filtration modules and filtration systems according to the invention are used in membrane bioreactors.

In one embodiment, membrane modules according to the invention have a dead-end configuration and/or can be operated in a dead-end mode.

In one embodiment, membrane modules according to the invention have a crossflow configuration and/or can be operated in a crossflow mode.

In one embodiment, membrane modules according to the invention have a directflow configuration and/or can be operated in a directflow mode.

In one embodiment, membrane modules according to the invention have a configuration that allow the module to be cleaned and scoured with air.

In one embodiment, filtration modules include a module housing, wherein at least one filtration element as described above is arranged within the module housing. Hereby the filtration element is arranged vertically or horizontally. The module housing is for instance made of fiber reinforced plastic (FRP) or stainless steel.

In one embodiment the at least one filtration element is arranged within the module housing such that the longitudinal center axis of the filtration element and the longitudinal center axis of the housing are superimposed. Preferably the filtration element is enclosed by the module housing, such that an annular gap is formed between the module housing and the element housing. The annular gap between the element housing and the module housing in operation allow for an even pressure distribution in axial direction along the filtration module.

In another embodiment the filtration element is arranged such that the at least one permeate collecting tube is located substantially at the top of the filtration module or filtration element. In this context substantially at the top includes any position in the outer part of the membrane element that lies within ±45°, preferred ±10°, particularly preferred ±5° from a vertical center axis in a transverse plane of the filtration element. Furthermore, the vertical center axis in a transverse plane is perpendicular to the horizontal center axis in the transverse plane and to the longitudinal center axis extending along the long axis of the filtration element. By arranging the permeate collecting tube this way, air residing within the filtration module or system before start up can be collected in the permeate collecting tube, which can then easily be vented upon start up by starting the filtration operation. In particular, air pockets can be displaced by permeate, which is fed to the filtration module or system on start up. By releasing air from the filtration module or system the active area of the membrane element is increased, thus increasing the filtering effect. Furthermore, the risk of fouling due to trapped air pockets decreases. Further preferred the filtration module is mount horizontally in order to orientate the permeate collecting tube accordingly.

In another embodiment the filtration element is arranged such that at least two permeate collecting tubes are arranged opposite each other in the outer part of the filtration element. In this embodiment the filtration module can be oriented such that one of the permeate collecting tubes are arranged substantially at the top of the filtration element, while the other tube is arranged substantially at the bottom of the filtration element. This way the ventilation can be achieved through the top tube, while the bottom tube allows for a higher output volume at a constant pressure. Furthermore, the permeate collecting tubes can have smaller dimensions compared to other configurations providing more space to be filled with the membrane element and thus increasing the filtration capacity.

In one embodiment, membrane modules according to the invention can have a configuration as disclosed in WO 2010/121628, S. 3, Z. 25 to p. 9, In 5 and especially as shown in FIG. 2 and FIG. 3 of WO 2010/121628.

In one embodiment membrane modules according to the invention can have a configuration as disclosed in EP 937 492, [0003] to [0020].

In one embodiment membrane modules according to the invention are capillary filtration membrane modules comprising a filter housing provided with an inlet, an outlet and a membrane compartment accommodating a bundle of membranes according to the invention, said membranes being cased at both ends of the membrane module in membrane holders and said membrane compartment being provided with discharge conduits coupled to the outlet for the conveyance of the permeate. In one embodiment said discharge conduits comprise at least one discharge lamella provided in the membrane compartment extending substantially in the longitudinal direction of the filtration membranes.

Another aspect of the invention are filtration systems comprising membrane modules according to the invention. Connecting multiple filtration modules normally increases the capacity of the filtration system. Preferably the filtration modules and the encompassed filtration elements are mounted horizontally and adapters are used to connect the filtration modules accordingly.

In one embodiment, filtration systems according to the invention comprise arrays of modules in parallel.

In one embodiment, filtration systems according to the invention comprise arrays of modules in horizontal position.

In one embodiment, filtration systems according to the invention comprise arrays of modules in vertical position.

In one embodiment, filtration systems according to the invention comprise a filtrate collecting vessel (like a tank, container).

In one embodiment, filtration systems according to the invention use filtrate collected in a filtrate collecting tank for backwashing the filtration modules.

In one embodiment, filtration systems according to the invention use the filtrate from one or more filtration modules to backwash another filtration module.

In one embodiment, filtration systems according to the invention comprise a filtrate collecting tube.

In one embodiment, filtration systems according to the invention comprise a filtrate collecting tube to which pressurized air can be applied to apply a backwash with high intensity.

In one embodiment, filtration systems according to the invention have a configuration as disclosed in EP 1 743 690, col. 2, In. 37 to col. 8, In. 14 and in FIG. 1 to FIG. 11 of EP 1 743 690; EP 2 008 704, col. 2, In. 30 to col. 5, In. 36 and FIG. 1 to FIG. 4; EP 2 158 958, col. 3, In. 1 to col. 6, In. 36 and FIG. 1.

In one embodiment filtration systems according to the invention comprise more than one filtration modules arranged vertically in a row, on both of whose sides an inflow pipe is arrayed for the fluid to be filtered and which open out individually allocated collecting pipes running lengthwise per row, whereby each filtration module has for the filtrate at least one outlet port which empties into a filtrate collecting pipe, whereby running along the sides of each row of filtration modules is a collecting pipe that has branch pipes allocated to said pipe on each side of the filtration module via which the allocated filtration module is directly connectable, wherein the filtrate collecting pipe runs above and parallel to the upper two adjacent collecting pipes.

In one embodiment, filtration systems according to the invention comprise a filtrate collecting pipe that is connected to each of the filtration modules of the respective filtration system and that is designed as a reservoir for backwashing the filtration system, wherein the filtration system is configured such that in backwashing mode pressurized air is applied to the filtrate collecting pipe to push permeate water from the permeate collecting pipe through the membrane modules in reverse direction.

In one embodiment, filtration systems according to the invention comprise a plurality of module rows arranged in parallel within a module rack and supplyable with raw water through supply/drain ports and each end face via respectively associated supply/drain lines and each including a drain port on a wall side for the filtrate, to which a filtrate collecting line is connected for draining the filtrate, wherein valve means are provided to control at least one filtration and backwashing mode, wherein, in the backwashing mode, a supply-side control valve of the first supply/drain lines carrying raw water of one module row is closed, but an associated drain-side control valve of the other supply/drain line of one module row serving to drain backwashing water is open, whereas the remaining module rows are open, to ensure backwashing of the one module row of the module rack by the filtrate simultaneously produced by the other module rows.

Hereinafter, when reference is made to the use of “membranes” for certain applications, this shall include the use of the membranes as well as filtration elements, membrane modules and filtration systems comprising such membranes and/or membrane modules.

In a preferred embodiment, membranes according to the invention are used for the treatment of sea water or brackish water or surface water.

In one preferred embodiment of the invention, membranes according to the invention, particularly RO, FO or NF membranes are used for the desalination of sea water or brackish water.

Membranes according to the invention, particularly RO, FO or NF membranes are used for the desalination of water with a particularly high salt content of for example 3 to 8% by weight. For example membranes according to the invention are suitable for the desalination of water from mining and oil/gas production and fracking processes, to obtain a higher yield in these applications.

Different types of membrane according to the invention can also be used together in hybrid systems combining for example RO and FO membranes, RO and UF membranes, RO and NF membranes, RO and NF and UF membranes, NF and UF membranes.

In another preferred embodiment, membranes according to the invention, particularly NF, UF or MF membranes are used in a water treatment step prior to the desalination of sea water or brackish water.

In another preferred embodiment membranes according to the invention, particularly NF, UF or MF membranes are used for the treatment of industrial or municipal waste water.

Membranes according to the invention, particularly RO and/or FO membranes can be used in food processing, for example for concentrating, desalting or dewatering food liquids (such as fruit juices), for the production of whey protein powders and for the concentration of milk, the UF permeate from making of whey powder, which contains lactose, can be concentrated by RO, wine processing, providing water for car washing, making maple syrup, during electrochemical production of hydrogen to prevent formation of minerals on electrode surface, for supplying water to reef aquaria.

Membranes according to the invention, particularly UF membranes can be used in medical applications like in dialysis and other blood treatments, food processing, concentration for making cheese, processing of proteins, desalting and solvent-exchange of proteins, fractionation of proteins, clarification of fruit juice, recovery of vaccines and antibiotics from fermentation broth, laboratory grade water purification, drinking water disinfection (including removal of viruses), removal of endocrines and pesticides combined with suspended activated carbon pretreatment.

Membranes according to the invention, particularly RO, FO, NF membranes can be used for rehabilitation of mines, homogeneous catalyst recovery, desalting reaction processes.

Membranes according to the invention, particularly NF membranes, can be used for separating divalent ions or heavy and/or radioactive metal ions, for example in mining applications, homogeneous catalyst recovery, desalting reaction processes.

### EXAMPLES

Abbreviations used in the examples and elsewhere:
DCDPS 4,4′-Dichlorodiphenylsulfone
DHDPS 4,4′-Dihydroxydiphenylsulfone
NMP N-methylpyrrolidone
DMAc Dimethylacetamide
PWP pure water permeation
MWCO molecular weight cut-off
DMF dimethylformamide
THF tetrahydrofurane
PESU polyethersulfone

The viscosity of copolymers was measured as a 1% by weight solution of the copolymer in NMP at 25° C. according to DIN EN ISO 1628-1.

Copolymers prepared were isolated from their solution by precipitation of solutions of the copolymers in water at room temperature (height of spray reactor 0.5 m, flux: 2.5 I/h). The so obtained beads were then filtered and washed with water/ethanol 1:1 (by volume) at room temperature. The beads were then dried to a water content of less than 0.1% by weight at 80 to 120° C. at 0.1 bar.

The molecular weight distribution and the average molecular weight of the polyarylene ether blocks and of the copolymers obtained were determined by GPC measurements.

GPC-measurements of PESU-based blocks were done using DMAc as solvent. After filtration (pore size 0.2 μm), 100 μl of this solution (4 mg/ml) was injected in the GPC system. For the separation 4 different columns (heated to 85° C.) were used (GRAM pre-column, GRAM 30A, GRAM 1000A, GRAM 1000A, separation material: polyester copolymers). The system was operated with a flow rate of 1 ml/min. As detection system an RI-detector was used (DRI Agilent 1100).

The calibration was done with PMMA samples of defined molecular weight and narrow molecular weight distribution.

GPC-measurements of PSU-based blocks were done using THF as solvent. After filtration (pore size 0.2 μm), 100 μl of this solution (2 mg/ml) was injected in the GPC system. For the separation 3 different columns (heated to 35° C.) were used (PLgel pre-column, 2 PLgel Mixed B, separation material: crosslinked PS/DVB). The system was operated with a flow rate of 2 ml/min. As detection system an RI-detector was used (DRI HP 1100).

The calibration was done with polystyrene samples of defined molecular weight and narrow molecular weight distribution.

The composition of the copolymers obtained with respect to the content of siloxane groups, ethylene groups and polyarylene ether units were determined by comparing the signal intensities in ¹H-NMR in CDCl₃.

The results of the evaluations are shown in tables 1 and 2.

Synthesis of Polyurethanes U

1. Synthesis of Polyarylene Ether Blocks

### Example 1.1

In a 4 liter glass reactor fitted with a thermometer, a gas inlet tube and a Dean-Stark-trap, 574.34 g of DCDPS, 510.00 g of Bisphenol A and 329.78 g of potassium carbonate with a volume average particle size of 32.4 μm were suspended in 950 ml NMP in a nitrogen atmosphere. The mixture was heated to 190° C. within one hour. In the following, the reaction time shall be understood to be the time during which the reaction mixture was maintained at 190° C.

The water that was formed in the reaction was continuously removed by distillation. The solvent level inside the reactor was maintained at a constant level by addition of further NMP. After a reaction time of six hours, a sample of 25 ml was taken from the flask and the reaction mixture was cooled to 120° C. 44.93 g of ethylene carbonate were added and the reaction mixture was stirred at 120° C. for two hours. 250 ml of cold (room temperature) NMP were added and the reaction mixture was let to cool to room temperature. The potassium chloride formed in the reaction was removed by filtration and the copolymer obtained was isolated as described above.

### Example 1.2

In a 4 liter glass reactor fitted with a thermometer, a gas inlet tube and a Dean-Stark-trap, 459.78 g of DCDPS, 456.56 g of Bisphenol A and 297.15 g of potassium carbonate with a volume average particle size of 32.4 μm were suspended in 950 ml NMP in a nitrogen atmosphere. The mixture was heated to 190° C. within one hour. In the following, the reaction time shall be understood to be the time during which the reaction mixture was maintained at 190° C.

The water that was formed in the reaction was continuously removed by distillation. The solvent level inside the reactor was maintained at a constant level by addition of further NMP. After a reaction time of six hours, a sample of 25 ml was taken from the flask and the reaction mixture was cooled to 120° C. 89.8 g of ethylene carbonate were added and the reaction mixture was stirred at 120° C. for two hours. 250 ml of cold (room temperature) NMP were added and the reaction mixture was let to cool to room temperature. The potassium chloride formed in the reaction was removed by filtration and the copolymer obtained was isolated as described above.

### Example 1.3

In a 4 liter glass reactor fitted with a thermometer, a gas inlet tube and a Dean-Stark-trap, 574.34 g of DCDPS, 510 g of Bisphenol A and 329.78 g of potassium carbonate with a volume average particle size of 32.4 μm were suspended in 950 ml NMP in a nitrogen atmosphere. The mixture was heated to 190° C. within one hour. In the following, the reaction time shall be understood to be the time during which the reaction mixture was maintained at 190° C.

The water that was formed in the reaction was continuously removed by distillation. The solvent level inside the reactor was maintained at a constant level by addition of further NMP. After a reaction time of six hours, 250 ml of cold (room temperature) NMP were added and the reaction mixture was let to cool to room temperature. The potassium chloride formed in the reaction was removed by filtration and the copolymer obtained was isolated as described above.

TABLE 1
Properties of copolymers obtained in examples 1.1 to 1.3.

| | | Terminal | Terminal |
|---|---|---|---|
| | Mw/Mn | OH-groups | EO-groups |
| Example | [g/mol] | [wt-%] | [wt-%] |
| 1.1 (intermediate sample) | 8500/4100 | 0.83 | — |
| 1.1 (final product) | 8800/4200 | <0.1 | 2.0 |
| 1.2 (intermediate sample | 4900/2600 | 1.67 | — |
| 1.2 (final product) | 5100/2650 | <0.1 | 3.1 |
| 1.3 | 9200/4380 | 0.82 | — |

### Example 2: Preparation of Polyurethanes

The products obtained in example 1.1 to 1.3 were used as starting materials for making polyurethanes using the procedure described in WO 2014/170391 p. 14, In 24 to p. 15, In 22 using polydimethylsiloxane-b-polyethyleneoxide (Wacker® IM22, Wacker Chemie, OH number 60.3 mg KOH/g according to DIN 53240) and 4,4′-MDI. The starting materials used and the properties of the copolymers obtained are given in table 2.

TABLE 2
Properties of copolymers 2.1 to 2.3.

| | polyarylene | amount of poly- | | |
|---|---|---|---|---|
| | ether used | dimethylsiloxane- | amount | |
| | (example no.) | b-Polyethylenoxid | of MDI | Mw/Mn |
| Example | amount used | (IM 22) used | used | [kD] |
| 2.1 | 1.1, 250 g | 62.5 g | 23.5 g | 44.1/14.2 |
| 2.2 | 1.2, 250 g | 62.5 | 36.0 | 42.1/13.7 |
| 2.3 | 1.3, 250 g | 62.5 | 23.9 | 21.2/8.4 |

The copolymers according to the invention show much higher molecular weight than those known from the art.

### Example 3: Preparation of Flat Sheet Membranes

Into a three neck flask equipped with a magnetic stirrer there were added 80 ml of N-methylpyrrolidone (NMP), 5 g of polyvinylpyrrolidone (PVP, Luvitec® K40) and 15 g of polyethersulfone or mixtures of polyethersulfone (Ultrason® E 6020P, viscosity number (ISO 307, 1157, 1628; in 0.01 g/mol phenol/1,2 orthodichlorobenzene 1:1 solution): 82; glass transition temperature (DSC, 10° C./min; according to ISO 11357-1/-2): 225° C.; molecular weight Mw (GPC in DMAc, PMMA standard): 75000 g/mol) and copolymers according to examples 2.1, 2.2 and 2.3. The composition of membranes prepared are given in table 3. The mixture was heated under gentle stirring at 60° C. until a homogeneous clear viscous solution was obtained. The solution was degassed overnight at room temperature. After that the membrane solution was reheated at 60° C. for 2 hours and casted onto a glass plate with a casting knife (300 microns) at 60° C. using an Erichsen Coating machine operating at a speed of 5 mm/min. The membrane film was allowed to rest for 30 seconds before immersion in a water bath at 25° C. for 10 minutes.

After the membrane had detached from the glass plate, the membrane was carefully transferred into a water bath for 12 h. Afterwards the membrane was transferred into a bath containing 2500 ppm NaOCl at 50° C. for 4.5 h to remove PVP. The membrane was then washed with water at 60° C. and one time with a 0.5 wt.-% solution of sodium bisulfite to remove active chlorine. After several washing steps with water the membrane was stored wet until characterization started.

Flat sheet continuous film with micro structural characteristics of UF membranes having dimension of at least 10×15 cm size were obtained. The membrane showed a top thin skin layer (1-3 microns) and a porous layer underneath (thickness: 100-150 microns).

Membrane Characterization:

Using a pressure cell with a diameter of 60 mm, the pure water permeation of the membranes was tested using ultrapure water (salt-free water, filtered by a Millipore UF-system). In a subsequent test, a solution of different PEG-Standards was filtered at a pressure of 0.15 bar. After filtration (pore size 0.2 μm), 100 μl of this solution (1.5 mg/ml) was injected in the GPC system. For the separation 2 columns (heated to 23° C.) were used (TSKgel GMPWXL, separation material: hydroxylated PMMA). The system was operated with a flow rate of 0.8 ml/min. As detection system an RI-detector was used (DRI Agilent 1200).

The calibration was done with PEG/PEO samples of defined molecular weight and narrow molecular weight distribution.

For mechanical testing dumbbell-shaped probes 7.5 cm long and 1.3/0.5 cm wide are cut out and used to evaluate the mechanical properties of the membranes according to ISO 527-1, Probe-Type 5A, speed: 50 mm/min, average values of 5 samples are given.

The obtained data are summarized in table 3

TABLE 3
Compositions and properties of membranes 3.1 to 3.8

| Experiment No. | 3.1 | 3.2 | 3.3 | 3.4 | 3.5 | 3.6 | 3.7 | 3.8 |
|---|---|---|---|---|---|---|---|---|
| PESU [wt.-%] | 15 | 14.25 | 14.25 | 14.25 | 17 | 16.15 | 16.15 | 16.15 |
| polymer 2.1 | 0 | 0.75 | 0 | 0 | 0 | 0.85 | 0 | 0 |
| [wt.-%] | | | | | | | | |
| polymer 2.2 | 0 | 0 | 0.75 | 0 | 0 | 0 | 0.85 | 0 |
| polymer 2.3 | 0 | 0 | 0 | 0.75 | 0 | 0 | 0 | 0.85 |
| [wt.-%] | | | | | | | | |
| PVP [wt.-%] | 5 | 5 | 5 | 5 | 5 | 5 | 5 | 5 |
| NMP [wt.-%] | 80 | 80 | 80 | 80 | 78 | 78 | 78 | 78 |
| PWP | 870 | 980 | 1020 | 670 | 720 | 820 | 870 | 590 |
| [kg/m2*h*bar] | | | | | | | | |
| MWCO [kg/mol] | 90 | 78 | 73 | 95 | 75 | 64 | 65 | 78 |
| Tensile Strength | 2.8 | 2.7 | 2.7 | 2.35 | 3.1 | 3.0 | 3.0 | 2.5 |
| [MPa] | | | | | | | | |
| Elongation at | 23 | 45 | 47 | 24 | 24 | 52 | 55 | 25 |
| Break [%] | | | | | | | | |

Membranes comprising polyurethane according to the invention as additives show improved mechanical properties over membranes known from the art. Membranes comprising polyurethane according to the invention as additives further show significantly improved permeabilities and MWCO.

1: A polymer composition, comprising:
a) an oligo- or polyurethane U of the formula I 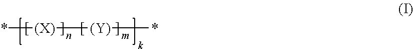
wherein
k and n independently are numbers from 1 to 100,
m is from the range 1-100,
(X) is a block of formula 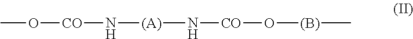
and (Y) is a block of the formula 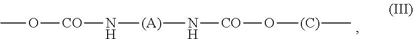
(A) is a residue of an aliphatic or aromatic diisocyanate linker,
(B) is a residue of a linear oligo- or polysiloxane comprising alkanol end groups, and optionally further comprising one or more aliphatic ether moieties, and
(C) is an aromatic oligo- or polyarylene ether block that is at least partly etherified at its terminal positions with one alkylene glycol unit;
or a mixture of such oligo- or polyurethanes; and
b) one or more further organic polymers P selected from the group consisting of polyvinyl pyrrolidone, polyvinyl acetates, cellulose acetates, polyacrylonitriles, polyamides, polyolefines, polyesters, polyarylene ethers, polysulfones, polyethersulfones, polyphenylenesulfones, polycarbonates, polyether ketones, sulfonated polyether ketones, polyamide sulfones, polyvinylidene fluorides, polyvinylchlorides, polystyrenes and polytetrafluorethylenes, copolymers thereof, and mixtures thereof; preferably selected from the group consisting of polysulfones, polyethersulfones, polyvinylidene fluorides, polyamides, cellulose acetate and mixtures thereof.

2: The polymer composition according to claim 1, wherein at least 70% of the terminal positions of said aromatic oligo- or polyarylene ether blocks (C) are etherified with one unit of ethylene glycol unit.

3: The polymer composition according to claim 1, wherein the molecular weight (Mn) of the compound of formula I is from the range 1500 to 500000, wherein n and m each are from the range 1 to 50, and k is from range 1 to 20.

4: The polymer composition according to claim 1, where in the oligo- or polyurethane U of the formula I
(A) is a divalent residue selected from C₂-C₁₂-alkylene and methyl-2,4-phenylene, methyl-2,6-phenylene, 3,3,5-trimethyl-5-methylen-3-cyclohexylen, and methylene-4,4′-diphenylen;
(B) is a divalent residue of an oligo- or polysiloxane of the formula
-[Ak-O]_{q}-Ak-Si(R₂)—[O—Si(R₂)]ₚ—O—Si(R₂)-Ak-[O-Ak]_{q}.- (IV)
wherein Ak represents C₂-C₄-alkylene, R stands for C₁-C₄-alkyl, and each of p, q and q′ independently is a number selected from the range 0-80;
(C) is a polyarylene ether block according to formula (V) 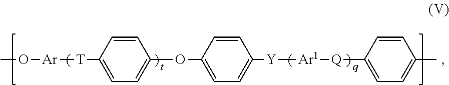
that is at least partly etherified at its terminal positions with one alkylene glycol unit.

5: The polymer composition according to claim 1, wherein polyurethane U comprises at least one copolymer selected from:
a) poly(polydimethylsiloxane-block-co-polysulfonyl)urethane derived from a polysulfone of formula 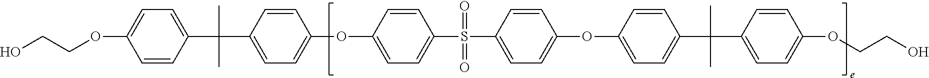
and polydimethylsiloxane of formula 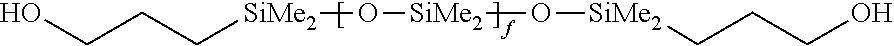
in a molar ratio ranging from 3:1 to 1:3, where e and fin both formulas is from the range 5 to 80, and 1,6-hexamethylene diisocyanate as linker;
b) poly(polydimethylsiloxane-block-co-polysulfonyl)urethane derived from a polysulfone of formula 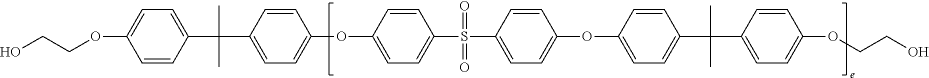
and polydimethylsiloxane of formula 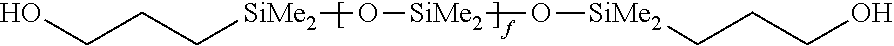
in a molar ratio ranging from 3:1 to 1:3, where e and fin both formulas is from the range 5 to 80, and 4,4′-methylenediphenyldiisocyanate as linker;
c) poly(polydimethyl siloxane-block-co-polyethylenoxid-block-co-polysulfonyl)urethane derived from a polysulfone of formula 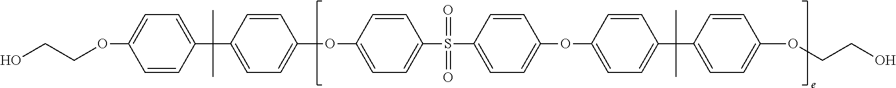
and polydimethylsiloxane of formula 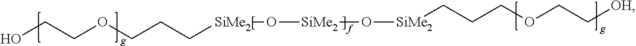
in a molar ratio ranging from 3:1 to 1:3, wherein e, f and g are from the range 5 to 80, and hexamethylene diisocyanate as linker;
d) poly(polydimethyl siloxane-block-co-polyethylenoxid-block-co-polysulfonyl)urethane derived from a polysulfone of formula 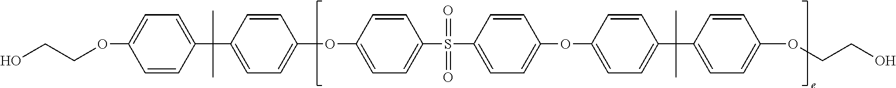
and polydimethylsiloxane of formula 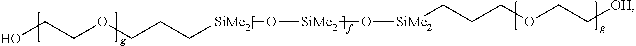
in a molar ratio ranging from 3:1 to 1:3, wherein e, f and g are from the range 5 to 80, and 4,4′-methylenediphenyldiisocyanate as linker.

6: The polymer composition according to claim 1, comprising the oligo- or polyurethane U of formula I in an amount of 0.1 to 25% by weight of the total polymer composition.

7: The polymer composition according to claim 1, further comprising one or more antimicrobial or bacteriostatic agent.

8: A membrane, comprising a polymer composition of claim 1.

9: The membrane of claim 8, having an at least 4-fold enrichment of silicon, in the section 2-10 nm from the membrane surface over the membrane's average silicon content.

10: The membrane according to claim 8, wherein said membrane is a UF, MF, RO, FO or NF membrane.

11: A method for water treatment applications, treatment of industrial or municipal waste water, desalination of sea or brackish water, dialysis, plasmolysis, or food processing, comprising applying the membrane according to claim 8.

12: A membrane element, comprising at least one membrane according to claim 8.

13: A membrane module, comprising at least one membrane according to claim 8.

14: A filtration system, comprising at least one membrane module according to claim 11.

15: A process for the preparation of a membrane, the process comprising incorporating a polymer composition according to claim 1 into a membrane material.

16: A process for preparation of an antimicrobial membrane, the process comprising incorporating a polymer composition according to claim 1 into a membrane material.

17: An oligo- or polyurethane compound of the formula I 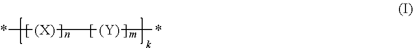
wherein k and n independently are numbers from 1 to 100,
m is from the range 1-100,
(X) is a block of formula 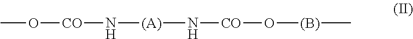
and (Y) is a block of the formula 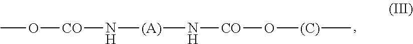
(A) is a residue of an aliphatic or aromatic diisocyanate linker,
(B) is a residue of a linear oligo- or polysiloxane containing alkanol end groups, and optionally further containing one or more aliphatic ether moieties, and
(C) is an aromatic oligo- or polyarylene ether block that is at least partly etherified at its terminal positions with one alkylene glycol unit.

18: The compound according to claim 17, the molecular weight (Mn) of the compound of formula I being from the range 1500 to 500000, wherein n and m are from the range 1 to 50, and k is from range 1 to 20.

19: A process for preparing a compound according to formula (I) according to claim 17, comprising:
a) reacting aromatic bishalogeno compounds and aromatic biphenols or salts thereof in the presence of at least one suitable base, wherein an excess of aromatic biphenols is used to obtain an OH-terminated polyarylene ethers;
b) reacting the OH-terminated polyarylene ether obtained in a) with ethylene carbonate;
c) reacting the compound obtained in b) with an aliphatic or aromatic diisocyanate linker;
d) reacting the compound obtained in c) with a linear oligo- or polysiloxane containing alkanol end groups, and optionally further containing one or more aliphatic ether moieties;
wherein d) is carried after c) and/or at least partly simultaneously with c).

20: The compound according to claim 17, which is selected from the group consisting of:
a) poly(polydimethylsiloxane-block-co-polysulfonyl)urethane derived from a polysulfone of formula 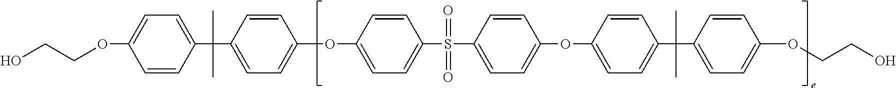
and polydimethylsiloxane of formula 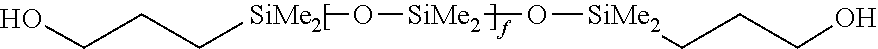
in a molar ratio ranging from 3:1 to 1:3, where e and fin both formulas is from the range 5 to 80, and 1,6-hexamethylene diisocyanate as linker;
b) poly(polydimethylsiloxane-block-co-polysulfonyl)urethane derived from a polysulfone of formula 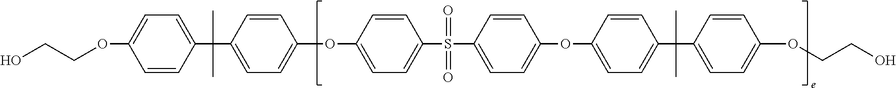
and polydimethylsiloxane of formula 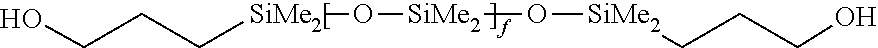
in a molar ratio ranging from 3:1 to 1:3, where e and fin both formulas is from the range 5 to 80, and 4,4′-methylenediphenyldiisocyanate as linker;
c) poly(polydimethyl siloxane-block-co-polyethylenoxid-block-co-polysulfonyl)urethane derived from a polyulfone of formula 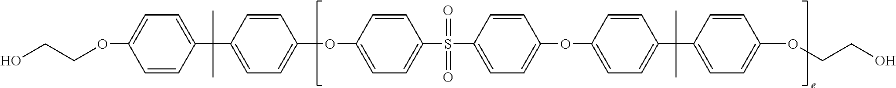
and polydimethylsiloxane of formula 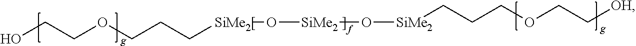
in a molar ratio ranging from 3:1 to 1:3, wherein e, f and g are from the range 5 to 80, and hexamethylene diisocyanate as linker;
d) poly(polydimethyl siloxane-block-co-polyethylenoxid-block-co-polysulfonyl)urethane derived from a polysulfone of formula 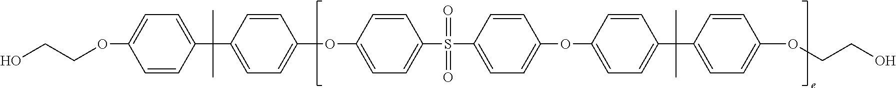
and polydimethylsiloxane of formula 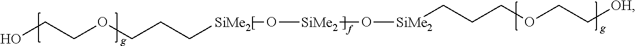
in a molar ratio ranging from 3:1 to 1:3, wherein e, f and g are from the range 5 to 80, and 4,4′-methylenediphenyldiisocyanate as linker.

21: A method for imparting antiadhesive or bacteriostatic properties to a polymer composition, comprising adding an oligo- or polyurethane according of formula I according to claim 17 as an additive to a polymer composition.
